(19) United States
(12) Patent Application Publication
(10) Pub. No.: US 2005/0221096 A1
(43) Pub. Date: Oct. 6, 2005

(54) Thermoplastic film for production of capacitors withstanding increased voltage, a process for its production, and its use

(76) Inventors: Holger Kliesch, Mainz (DE); Ursula Murschall, Nierstein (DE); Ulrich Kern, Ingelheim (DE); Bodo Kuhmann, Runkel (DE)

Correspondence Address: PROPAT, L.L.C., 425-C SOUTH SHARON AMITY ROAD, CHARLOTTE, NC, 28211-2841, US

(21) Appl. No.: 11/087,936

(22) Filed: Mar. 23, 2005

(30) Foreign Application Priority Data
Apr. 1, 2004 (DE) 10 2004 016 054.6

(51) Int. Cl. C08G 63/02

(52) U.S. Cl. 428/423.1

(57) ABSTRACT

The invention relates to a conductively coated, oriented film formed from a thermoplastic, the thickness of the film being in the range from 0.5 to 12 μm. The film features good dielectric properties. It moreover comprises not only a conductive coating but also a stabilizer to withstand increased voltage. The invention further relates to the use of the film in film capacitors, and also to a process for its production.

### FIELD OF THE INVENTION

The invention relates to a conductively coated, oriented film comprised of a thermoplastic, the thickness of the film being in the range from 0.5 to 12 μm. The film features good dielectric properties. It moreover comprises not only a conductive coating but also a stabilizer to withstand increased voltage. The invention further relates to the use of the polyester film in film capacitors, and also to a process for its production.

### BACKGROUND OF THE INVENTION

Films comprised of thermoplastics in the stated thickness range, suitable for production of film capacitors are well-known.

Films for production of capacitors have to meet stringent requirements with respect to their dielectric strength and their dielectric absorption, in order to ensure that the capacitor withstands a sufficient voltage, and to prevent their temperature from rising by more than a very small amount during the process of charging and discharging. As described inter alia in EP-A-0 791 633, this is ensured via high purity of the raw materials used. That specification says nothing about antimony crystals or the use of additional stabilizers.

The catalysts used industrially for polycondensation of polyesters are antimony compounds, titanium compounds, and germanium compounds or, respectively, salts. Germanium-based catalysts have the highest catalytic activity in this group, followed by titanium catalysts. Antimony catalysts, in contrast, have the lowest relative activity. However, by far the greatest portion of the polyesters used in the global market is prepared with the aid of antimony catalysts. The reason for this is that germanium catalysts are generally uneconomic because their price is extremely high, and titanium catalysts lead to undesired yellowing and reduced thermal stability of the raw material. These disadvantageous properties are caused by side reactions which, as shown by our internal studies, bring about not only formation of an increased number of undesirable gel particles but also a marked reduction in process stability.

Polyester films are generally produced from plastics pellets melted in an extruder. The resultant plastics melt is molded to give what is known as a prefilm, by way of a flat-film die. The prefilm is then applied to a roll for draw-off and chilling, then oriented longitudinally and transversely, and finally wound up. These films are intended to have a minimum number of gel particles and of other defects which impair appearance or further processing. Gel particles reduce process stability in film production, i.e. they lead to undesired break-offs. In addition, gel particles block the filters in the extrusion area, leading to further losses of cost-effectiveness.

When large changes in field strength occur as a function of time, e.g. during charging and discharging of the capacitor, the result within the dielectric is formation of charge carriers and motion of these, with resultant local increase in the temperature of the capacitor film. However, the charge carriers may also have entered the raw material previously by virtue of the catalyst system, or may be formed via bond cleavage due to the electrical pulse. In particular this produces free-radical charge carriers which undergo addition to the charge carriers present by this stage within the raw material. During the pulse, there are also mechanical and thermomechanical forces acting on the film layers and in the least favorable case these can lead to separation of individual layers from the Schoop layer.

### BRIEF SUMMARY OF THE INVENTION

It is an object of the invention to provide a film which does not have the disadvantages described of the prior art.

The invention provides a conductively coated, oriented film comprised of a thermoplastic with a thickness in the range from 0.5 to 12 μm, which comprises, alongside a conductive coating, amounts of from 50 to 15 000 ppm, based on the weight of the film, of at least one stabilizer.

The invention further provides the use of this film in film capacitors, and also a process for its production.

The term “stabilizer” refers to compounds which are used in the film as free-radical scavenger or as heat stabilizer, and specifically and preferably in amounts of from 100 to 5000 ppm, particularly preferably from 300 to 1000 ppm, based on the weight of the film. They serve to scavenge the charge carriers formed during voltage changes within the film capacitors used.

### DETAILED DESCRIPTION OF THE INVENTION

The film comprises a thermoplastic as main constituent. Examples of suitable thermoplastics are polyethylene terephthalate (PET), polyethylene naphthalate (PEN), polybutylene terephthalate (PBT), bibenzoyl-modified polyethylene terephthalate (PETBB), bibenzoyl-modified polybutylene terephthalate (PBTBB), and bibenzoyl-modified polyethylene naphthalate (PENBB), or a mixture of these, preferably PET, PBT or PEN.

Compounds which may also be used for production of thermoplastic polyesters, alongside the main monomers, such as dimethyl terephthalate (DMT), ethylene glycol (EG), propylene glycol (PG), butane-1,4-diol, terephthalic acid (TA), benzenedicarboxylic acid, and/or naphthalene-2,6-dicarboxylic acid (NDA) are isophthalic acid (IPA) and/or cis- and/or trans-1,4-cyclohexanedimethanol (c-CHDM, t-CHDM or c/t-CHDM), and other suitable dicarboxylic acid components (or dicarboxylic esters) and diol components.

Preference is given here to polymers in which the dicarboxylic acid component is comprised of more than 95% of terephthalic acid or of naphthalene-2,6-dicarboxylic acid (NDA). Particular preference is given to polymers in which the dicarboxylic acid component is comprised of more than 98% of one of the two abovementioned dicarboxylic acid components. Preference is moreover given to polymers in which the diol component is comprised of more than 90% of ethylene glycol. Particular preference is given to polymers in which the diol component is comprised of more than 93% of ethylene glycol. Preference is also given to polymers in which the diethylene glycol content of the entire polymer is from 1 to 2%.

The polymer may moreover comprise inorganic or organic particles which are needed to adjust the surface topography. Examples of suitable particles are calcium carbonate, apatite, silicon dioxide, titanium dioxide, aluminum oxide, crosslinked polystyrene, zeolites, and other silicates and aluminum silicates.

To increase ability to withstand pulses, it has proven advantageous for the average melt resistivity of the thermoplastic used to be ≧1*10⁷ Ω cm, preferably ≧10*10⁷ Ω cm, and particularly preferably ≧25*10⁷ Ω cm and ≦150*10⁷ Ω cm. The average is calculated from the formula
1/(x₁*1/W₁+x₂*1/W₂+ . . . +Xₙ*1/Wₙ)
where x₁ (xₙ)=proportion of thermoplastic of component 1(n), and
W₁ (Wₙ)=resistivity of thermoplastic of component 1(n).

These melt resistivities are adjusted by the person skilled in the art by way of the ratios by weight of the catalysts present in the polymer and derived from its preparation (antimony, titanium, calcium, manganese, etc.), and the phosphorus stabilizer components usually used in polyester preparation. By way of example, a polymer prepared with 300 ppm of Sb₂O₃ as catalyst and 200 ppm of calcium acetate, and also 130 ppm of phosphorous acid, gives a melt resistivity (30*10⁷ Ω cm) in the desired range. Phosphorus stabilizer in this context does not mean the abovementioned free-radical scavengers, but describes compounds suitable for scavenging alkaline earth metal ions.

In one preferred embodiment comprised of polyethylene terephthalate, the standard viscosity SV (DCA) of the film is generally in the range from 600 to 1000, preferably from 700 to 900. Depending on the SV loss caused by the extrusion process (dependent on the selected dryer type and conditions), the average SV of the starting raw materials is from 5 to 70 units above the ranges mentioned for the film.

Alongside the additives mentioned, the film may also comprise other components, such as hydrolysis stabilizers and/or other polymers, such as polyetherimides.

The inventive film generally has one layer. For specific applications, however, it may also be a multilayer film, e.g. a coextruded film.

The stabilizers added to the thermoplastic raw material during the preparation of the thermoplastic are selected as desired from the group of the primary stabilizers, such as sterically hindered phenols or secondary aromatic amines, or from the group of the secondary stabilizers, e.g. thioethers, phosphites, and phosphonites, and also zinc dibutyldithiocarbamate, or synergistic mixtures comprised of primary and secondary stabilizers.

Preference is given to the phenolic stabilizers. Among these are in particular sterically hindered phenols, thiobisphenols, alkylidenebisphenols, alkylphenols, hydroxybenzyl compounds, acrylic aminophenols, and hydroxyphenylpropionates (appropriate compounds being described by way of example in “Kunststoffadditive” [Plastics additives], 2^{nd} edition, Gächter Müller, Carl Hanser-Verlag, and in “Plastics Additives Handbook”, 5^{th} Edition, Dr Hans Zweifel, Carl Hanser-Verlag).

Particular preference is given to the stabilizers with the following CAS numbers: 6683-19-8, 36443-68-2, 35074-77-2, 65140-91-2, 23128-74-7, 41484-35-9, 2082-79-3, and also IRGANOX® 1222 from Ciba Specialties, Basle, Switzerland, or a mixture of these. Examples of these compounds are IRGANOX® 1010, IRGANOX® 1222, IRGANOX® 1330 and IRGANOX® 1425.

If the stabilizer with the CAS number 65140-91-2, which contains calcium ions, is used, it has proven advantageous to add to the raw material an amount of phosphorus derived from phosphorous acid or from other phosphorus stabilizers which corresponds to at least 30% of the amount of stabilizer in ppm. This amount of phosphorus stabilizer inhibits movement, in the electrical field, of the calcium ions from CAS number 65140-91-2 when the film is used in film capacitors.

In the case of the DMT process, the stabilizers are usually added after the transesterification process or directly prior to the polycondensation process, or else during the polycondensation process, in the form of a glycolic solution or glycolic dispersion. Particular preference is given here to the stabilizers which are incorporated into the polymer chain during production of the raw material, because these cannot then migrate within the electrical field when the film is used in film capacitors. Examples of these stabilizers are those with the CAS numbers 6683-19-8, 36443-68-2, 35074-77-2, 23128-74-7, 41484-35-9, and 2082-79-3. For the purposes of the invention, preference is given to the use of IRGANOX® 1010.

The amounts added of the stabilizers mentioned are those stated above.

These stabilizers which act as free-radical scavengers are known to be effective in reducing crosslinking in polyester materials. However, because under conventional processing conditions polyester raw materials mainly comprised of PET or PEN (more than 90%) exhibit only a very low level of side reactions capable of suppression by stabilizers of this type, polyester films are generally produced without addition of these compounds. However, use may be advisable on economic grounds for certain process conditions or applications requiring particularly low gel particle concentrations.

Antimony-catalyzed raw materials generally comprise antimony crystals, which form from the antimony compounds used in a side reaction. Antimony crystals are metallic conductors and reduce the voltage that the capacitors can withstand. It is therefore desirable for a capacitor film to comprise no, or only very small, antimony crystals.

It has proven advantageous to use raw materals which, if antimony-catalyzed, comprise inorganic particles, such as precipitated synthetic or natural silicas, aluminum silicates, or apatite-like particles with a d₅₀ diameter ≧1 μm at a concentration of from 50 to 50 000 ppm. Surprisingly, no Sb crystals whose d₅₀ value is ≧0.5 μm are found in raw materials of this type which comprise the particles mentioned.

If use is made of raw materials in which no inorganic particles of this type are present, it has moreover proven advantageous to use thermoplastics whose preparation has used no Sb compounds as polycondensation catalysts, examples being titanium-catalyzed polyesters.

The best results with respect to the voltage that film capacitors can withstand are achieved using raw materials in which no antimony is present as polycondensation catalyst, and if at least one of the raw materials used comprises the abovementioned inorganic particles. It is also advantageous if at least 25%, preferably at least 30%, particularly preferably at least 40%, of the amount of raw material used comprises, as free-radical scavenger, the stabilizers described above.

If use is made of antimony-catalyzed raw mateirals which comprise no inorganic particles, or comprise inorganic particles sized below 1 μm, the result is formation of antimony crystals, or the presence of particles with a covering comprised of metallic antimony. Antimony crystals are likewise found if use is made of particles not completely bound within the polymer matrix, e.g. calcium carbonate particles.

In one preferred embodiment, the films are low-shrinkage films and moreover the capacitors produced with the films of the invention are capable of SMD soldering. Capable of SMD soldering means that at the conventional temperatures above 220° C. for reflow soldering the capacitors do not undergo mechanical deformation and retain electrical stability.

Low shrink means that MD shrinkage of the film at 200° C. is ≦4% and ≦0.1%, preferably ≦3.5% and ≧0.5%. The TD shrinkage of the film at 200° C. is ≦2%.

Cost-effective production includes the ability of the raw materials or raw material components needed for production of the film to be dried by commercially available industrial dryers, such as vacuum dryers, fluidized-bed dryers, or fixed-bed dryers (tower dryers). It is important that the raw mateirals do not cake and do not undergo thermal degradation. The dryers mentioned operate at temperatures of from 100 to 170° C. In capacitor film production, even non-aggressive vacuum dryers with drying temperatures below 130° C. require after-dryers (hoppers) with temperatures above 100° C.

The thermoplastic film which serves as base film for the capacitor film of the invention is generally produced by extrusion processes known per se.

The procedure for one of these processes is that the appropriate melts are extruded through a flat-film die, the resultant film is drawn off and quenched on one or more rolls (chill roll) for solidification in the form of a substantially amorphous prefilm, and the film is then reheated and biaxially stretched (oriented), and the biaxially stretched film is heat-set.

The biaxial orientation is generally carried out sequentially. This orientation preferably takes place first longitudinally (i.e. in machine direction=MD) and then transversely (i.e. perpendicularly to the machine direction=TD). This leads to orientation of the molecular chains. The longitudinal orientation can be carried out with the aid of two rollers running at different speeds corresponding to the desired stretching ratio. For the transverse orientation, use is usually made of an appropriate tenter frame.

The temperature at which the orientation is carried out can vary within a relatively wide range and depends on the desired properties of the film. The longitudinal stretching and also the transverse stretching are generally carried out at from T_{G}+10° C. to T_{G}+60° C. (T_{G}=glass transition temperature of the film). The longitudinal stretching ratio is generally in the range from 2:1 to 6:1, preferably from 3:1 to 4.5:1. The transverse stretching ratio is generally in the range from 2:1 to 5:1, preferably from 3:1 to 4.5:1, and the ratio of any second longitudinal and transverse stretching carried out is from 1.1:1 to 5:1.

The first longitudinal stretching may, if appropriate, be carried out simultaneously with the transverse stretching (simultaneous stretching). It has proven particularly advantageous for the stretching ratio in each direction, longitudinal and transverse, to be greater/equal than 3.5.

In the heat-setting which follows, the film is kept for from about 0.1 to 10 seconds at a temperature of from 180 to 260° C., preferably from 220 to 245° C. Following heat-setting, or beginning during heat-setting, the film is relaxed by from 0 to 15%, preferably by from 1.5 to 8%, transversely and, if appropriate, also longitudinally, and in one particularly preferred embodiment here at least the final 2% of relaxation takes place at temperatures below 200° C. The film is then cooled and wound up.

The wound-up film is then provided with a conductive coating. To this end, it is slit to give widths suitable for conventional metallizing machines (e.g. from Applied Films, prev. Leybold) (e.g. 500 mm width), and then metallized by the known processes (coating with another conductive material, such as conductive polymers, being also possible), and then slit to the desired width for capacitor production. These “metallized narrow-cuts” are then used to manufacture capacitor windings which are then pressed flat (temperatures of from 0 to 280° C.), schooped, and provided with contacts.

One capacitor-production method preferred for the purposes of the invention is winding of the narrow cuts on wheels or bars, which are schooped, heat-stabilized in an oven (temperatures of from 100 to 280° C.), and then cut to give the appropriate capacitor widths (film capacitors) which are then provided with contacts. If appropriate, the heat-conditioning here may also take place prior to schooping.

The voltage which a capacitor can withstand is generally dependent on the thickness of the dielectric, and on the nature of the capacitor (wound capacitor or film capacitor) and the conductive coating. Ability to withstand high voltage means that the capacitors produced from the inventive film with stabilizer can withstand from 5 to 20% higher voltage than capacitors produced under the same conditions from commercially available capacitor films of the same thickness.

The same applies for the use of stabilizer and simultaneous use of raw materials without antimony crystals. The voltage that can be withstood here by capacitors comprised of this film is from 10 to 25% higher. If low-shrinkage film with stabilizer and without antimony crystals is used, the increase in performance rises to from 15 to 30%.

The range of improvement is dependent on whether wound capacitors or film capacitors are used, the improvement being greater in the case of film capacitors. Greater thickness of metallization at the edge likewise leads to an improvement in the difference between conventional capacitor films and films of the invention.

The very good electrical properties, e.g. the ability of the capacitors comprised of the films of the invention to withstand high voltage and to withstand pulses, are particularly surprising. The films therefore have particularly good suitability for production of capacitors, such as wound capacitors or film capacitors, preferably link capacitors. For example, these capacitors exhibit no failure in this particularly sensitive application, despite the use of the additives, such as stabilizers and free-radical scavengers.

Measurement of individual properties in the examples below takes place in accordance with the stated standards or methods.

Measurement Methods

Melt Resistivity

15 g of raw material are placed in a glass tube and dried for 2 hours at 180° C. The tube is immersed in a 285° C. oil bath, and is evacuated. The melt is freed from bubbles via stepwise reduction of pressure to 0.1*10⁻² bar (defoamed). The tube is then flushed with nitrogen, and the electrodes preheated to 200° C. (two platinum sheets (A=1 cm²)) are slowly immersed into the melt at a distance of 0.5 cm from one another. After 7 minutes, the measurement takes place at a test voltage of 100 V (Hewlett Packard 4329 A high-resistance meter), the value being measured two seconds after application of the voltage.

Shrinkage

Thermal shrinkage is determined twice on two square film sections, edge length being 10 cm in each case, one edge of the respective film section here having orientation parallel to the machine direction. The edge lengths of the specimens are measured precisely prior to heating (LO) and the specimens are heat-conditioned for 15 minutes in an oven with air circulation at the respective stated temperature. The heat-conditioned specimens (L) are then removed from the oven, and the length of an appropriate edge is measured precisely at room temperature and compared with the length prior to heat-conditioning.

Voltage Test

A voltage is applied (maximum voltage rise in V/μs=(thickness in μm)*20) to the finished capacitors at 25° C. for 2 seconds. The initial voltage depends on the thickness of the film used and is calculated from
voltage in volts=69*(thickness in μm) ^{1.3629}

The voltage test is regarded as passed for each capacitor if the voltage does not reduce by more than 20% during the two seconds.

The voltage applied is then increased in 5-volt steps until 3 of 10 capacitors have failed. The voltage achieved at this point is taken as a measure of the voltage that can be withstood.

SMD Soldering Capability

The finished capacitors are placed for 2 minutes in an oven at 235° C. They are then subjected to the voltage test. The conditions remain the same as for the voltage test. However, the test is regarded as passed only if no deformation of the capacitors is visually discernible.

### EXAMPLES

Each of the examples and comparative examples below uses films of different thickness, produced by a known extrusion process. In each case, capacitors are manufactured from the resultant film.

Raw Materials Used

All of the constituents in the individual masterbatches and in the raw materials are added during PET preparation. The mineral additives are dispersed in glycol prior to addition to the reaction mixture, and are adjusted to the stated particle sizes in a bead mill.

Polyester masterbatch MB1 comprises, alongside PET content, 1% by weight of Sylysia® 320 (Fuji, Japan), d₅₀ value 2.4 μm, and 3% by weight of AEROSIL® TT600 (Degussa). The SV value of the polymer is 800. The masterbatch comprises 250 ppm of antimony trioxide as polycondensation catalyst from the PET preparation process and also 5000 ppm of IRGANOX® 256 (Ciba Specialties, Switzerland), added as glycolic dispersion during the raw material preparation process prior to transesterification.

Polyester masterbatch MB2 has the same constitution as MB1, except that no IRGANOX® 256 is present.

Polyester masterbatch MB3 comprises, alongside PET content, 1% by weight of SYLOBLOC® 44H (Grace, Germany), d₅₀ value 2.6 μm, and 3% by weight of AEROSIL® TT600. The SV value of the polymer is 800. The masterbatch comprises 12 ppm of titanium derived from titanium catalyst C94 (Synetix) as polycondensation catalyst from the PET preparation process and also 6000 ppm of IRGANOX® 1010, added as glycolic dispersion during the raw material preparation process prior to transesterification.

Polyester masterbatch MB4 has the same constitution as MB3, except that no IRGANOX® 1010 is present.

Polyester masterbatch MB5 comprises, alongside PET content, 1% by weight of HYDROCARB® 70 calcium carbonate (Omya), d₅₀ value 1.6 μm. The SV value of the polymer is 800. The masterbatch comprises 12 ppm of titanium derived from titanium catalyst C94 as polycondensation catalyst from the PET preparation process and also 6000 ppm of IRGANOX® 1010, added as glycolic dispersion during the raw material preparation process prior to trans-esterification.

Polyester masterbatch MB6 has the same constitution as MB5, except that no IRGANOX® 1010 is present.

Polyester masterbatch MB7 comprises, alongside PET content, 1% by weight of HYDROCARB® 70 calcium carbonate, d₅₀ value 1.6 μm. The SV value of the polymer is 800. The masterbatch comprises 250 ppm of antimony trioxide as polycondensation catalyst from the PET preparation process and also 6000 ppm of IRGANOX® 1010, added as glycolic dispersion during the raw material preparation process prior to transesterification.

Raw material R1 is comprised of polyethylene terephthalate, SV value 820. It comprises 300 ppm of antimony trioxide as polycondensation catalyst from its preparation process.

Raw material R2 is comprised of polyethylene terephthalate, SV value 820. It comprises 12 ppm of titanium derived from titanium catalyst C94 as polycondensation catalyst from its preparation process.

Raw material R3 is comprised of polyethylene terephthalate, SV value 820. It comprises, alongside PET, 1000 ppm of SYLOBLOC® 44H, d₅₀ value 2.4 μm, and 3000 ppm of OMYALITH® 90 (Omya), d₅₀ value 1.0 μm. It also comprises 300 ppm of antimony trioxide as polycondensation catalyst and also 500 ppm of IRGANOX® 1010, added as glycolic dispersion during the raw material preparation process prior to transesterification.

Raw material R4 is comprised of polyethylene terephthalate, SV value 820. It comprises, alongside PET, 1000 ppm of SYLOBLOC® 44H, d₅₀ value 2.4 μm, and 3000 ppm of OMYALITH 90, d₅₀ value 1.0 μm. The raw material comprises 300 ppm of antimony trioxide as polycondensation catalyst.

Raw material R5 has the same constitution as R4, but 500 ppm of IRGANOX® 1010 is also present, added as glycolic dispersion during the raw material preparation process prior to transesterification. The raw material also comprises 10 ppm of potassium acetate.

The melt resistivity of the raw materials MB1 to MB7 and R1 to R4 used was from 25*10⁷ to 30*10⁷ Ω cm. The melt resistivity of R5 was 0.5*10⁷ Ω cm.

Film Production

The PET chips were mixed in the ratio stated in the examples, and precrystallized for 1 minute at 155° C. in a fluidized-bed dryer, and then dried at 150° C. for 3 hours in a tower dryer and extruded at 290° C. The molten polymer emerging from the die is cooled and drawn off by way of a draw-off roll. The film of thickness 43 μm was stretched by a factor of 3.8 in the machine direction at 116° C. Transverse stretching by a factor of 3.7 took place at 110° C. in a frame. The film was then heat-set at 239° C. The film was then relaxed transversely by 4% at temperatures of from 230 to 190° C. and then again relaxed by 3% at temperatures of from 180 to 130° C. This gave a final film thickness of 2 μm.

Capacitor Production

Each film was provided with a vapor-deposited aluminum layer of thickness about 500 Angstrom, masking strips being used to produce an unmetallized strip of width 2 mm between each of the metallized strips of width 18 mm, and the film was then cut into strips of width 10 mm so that the unmetallized strip (free edge) of width 1 mm remained at the edge. Two strips each of length 600 meters, one with the free edge on the left-hand side and one with the free edge on the right-hand side, were wound together onto a metal wheel of diameter 20 cm. There was an offset between the two strips here, amounting to 0.5 mm in the direction of width. 10 layers of unmetallized film (identical film) were wound up both above and below the metallized strips. A metal tape was drawn tight over the uppermost layer, using a pressure of 0.1 kg/cm². The winding on the wheel was then schooped on both sides, provided with a vapor-deposited silver layer of thickness 0.2 mm, and heat-conditioned at 195° C. for 60 minutes in an oven (flushed with dry nitrogen). The metal tape was then removed from the wheel winding, and the material was then cut at intervals of 0.7 cm to give individual capacitors.

Films with the following mixing specifications were produced in accordance with the above specification:

| | |
|---|---|
| Example 1: | 20% by weight of MB1, 80% by weight of R1 |
| Example 2: | 20% by weight of MB1, 80% by weight of R2 |
| Comparative example 1: | 20% by weight of MB2, 80% by weight of R1 |
| Example 3: | 20% by weight of MB3, 80% by weight of R1 |
| Example 4: | 20% by weight of MB3, 80% by weight of R2 |
| Comparative example 2: | 20% by weight of MB4, 80% by weight of R1 |
| Comparative example 3: | 20% by weight of MB4, 80% by weight of R2 |
| Example 5: | 20% by weight of MB5, 80% by weight of R1 |
| Example 6: | 20% by weight of MB5, 80% by weight of R2 |
| Example 7: | 20% by weight of MB7, 80% by weight of R2 |
| Comparative example 4: | 20% by weight of MB6, 80% by weight of R1 |
| Example 8: | 100% by weight of R3 |
| Example 9: | 100% by weight of R5 |
| Comparative example 5: | 100% by weight of R4 |

Capacitors were produced as described above from the films.

The following table gives the voltages that the capacitors can withstand.

TABLE

| Example/Comparative | Voltage |
|---|---|
| example | withstood in V |
| Example 1 | 352 |
| Example 2 | 365 |
| Comparative example 1 | 310 |
| Example 3 | 349 |
| Example 4 | 363 |
| Comparative example 2 | 312 |
| Comparative example 3 | 321 |
| Example 5 | 348 |
| Example 6 | 361 |
| Example 7 | 347 |
| Comparative example 4 | 305 |
| Example 8 | 345 |
| Example 9 | 330 |
| Comparative example 5 | 325 |

In each case, comparison of the example/comparative example groups clearly shows that addition of IRGANOX® to the raw material raises the voltage that can be withstood. Another improvement is obtained if use of titanium-catalyzed raw materials results in absence of antimony crystals or if suitable particles are used to suppress these in the masterbatches. Excessive conductivity (low melt resistivity) as in Example 9 causes impairment.

1. A conductively coated, oriented film with a thickness in the range from 0.5 to 12 μm, said film comprising thermoplastic and at most one stablizer, said film further comprising a conductive coating, said stabilizer present in said film in amounts of from 50 to 15 000 ppm, based on the weight of the film.

2. The film as claimed in claim 1, wherein the amounts of the stabilizer present are from 100 to 5000 ppm, and the stabilizer is a primary or secondary stabilizer.

3. The film as claimed in claim 1, which comprises no antimony crystals.

4. The film as claimed in claim 1, wherein the thermoplastic comprises polyethylene terephthalate (PET), polyethylene naphthalate (PEN), polybutylene terephthalate (PBT), or a mixture thereof.

5. The film as claimed in claim 1, wherein the thermoplastic comprises inorganic or organic particles.

6. The film as claimed in claim 1, said film comprising one or more layers.

7. The film as claimed in claim 1, wherein said film has been metallized or has been coated with another conductive material.

8. A process for the production of a conductively coated, oriented film which comprises, as main constituent, a crystallizable thermoplastic and which has a thickness in the range from 0.5 to 12 μm, which comprises
(a) extruding a crystallizable thermoplastic and amounts of from 50 to 15 000 ppm, based on the weight of the film, of at least one stabilizer to give a flat melt film,
(b) quenching the material with the aid of a chill roll for solidification,
(c) drawing off the resultant substantially amorphous film on one or more rolls,
(d) biaxially stretching the film to orient it,
(e) heat-setting, and relaxing the oriented film, and
(f) providing the heat-set and relaxed film with a conductive coating.

9. A capacitor comprising film as claimed in claim 1.

10. A capacitor according to claim 9, wherein said capacitor is a wound capacitor or a multilayer capacitor.

11. A capacitor according to claim 10, wherein the capacitor is an intermediate circuit capacitor.

12. A film according to claim 2, wherein the stabilizer is a phenolic stabilizer.
